(19) United States
(12) Patent Application Publication
(10) Pub. No.: US 2025/0314333 A1
(43) Pub. Date: Oct. 9, 2025

(54) CLIP FOR THERMOCOUPLE CABLES

(71) Applicants: Sheila Vazquez, Converse, TX (US); Armin Tay, Waco, TX (US); Anthony Vu, Rockville, MD (US); Alexander Thompson, Wendell, NC (US); Jagger Butler, College Station, TX (US)

(72) Inventors: Sheila Vazquez, Converse, TX (US); Armin Tay, Waco, TX (US); Anthony Vu, Rockville, MD (US); Alexander Thompson, Wendell, NC (US); Jagger Butler, College Station, TX (US)

(21) Appl. No.: 18/797,482

(22) Filed: Aug. 7, 2024

Related U.S. Application Data
(63) Continuation-in-part of application No. 18/628,780, filed on Apr. 7, 2024.
(60) Provisional application No. 63/663,153, filed on Jun. 23, 2024.
(60) Provisional application No. 63/664,814, filed on Jun. 27, 2024.
(60) Provisional application No. 63/665,284, filed on Jun. 28, 2024.
(60) Provisional application No. 63/666,666, filed on Jul. 2, 2024.
(60) Provisional application No. 63/667,062, filed on Jul. 2, 2024.
(60) Provisional application No. 63/667,139, filed on Jul. 3, 2024.

(51) Int. Cl. F16L 3/10

(52) U.S. Cl. CPC F16L 3/10; F16L 2201/60

(57) ABSTRACT

A cable clip that ties cables together so that each cable can be easily identified, and that allows the bound cables to be easily transported and easily placed into their designated location. Additionally, the clip will also prevent cables from getting entangled, and allows specific cables to be easily removed and/or replaced while leaving all other cables in place. The cable clip is primarily designed for Thermocouple Cables (TC's), but can also be used with LAN Cables or any other type of cables.

### CROSS-REFERENCE TO RELATED APPLICATIONS

This invention is a Continuation-in-part (CIP) of U.S. Patent Application #18/628,780, which was filed on 7 Apr. 2024; in addition, this invention is entitled to the benefits of:
Provisional Patent Application (PPA) Ser. #63/663,153 filed on 23 Jun. 2024
Provisional Patent Application (PPA) Ser. #63/664,814 filed on 27 Jun. 2024
Provisional Patent Application (PPA) Ser. #63/665,284 filed on 28 Jun. 2024
Provisional Patent Application (PPA) Ser. #63/666,666 filed on 2 Jul. 2024
Provisional Patent Application (PPA) Ser. #63/667,062 filed on 2 Jul. 2024
Provisional Patent Application (PPA) Ser. #63/667,139 filed on 3 Jul. 2024

### BACKGROUNG-FIELD OF INVENTION

This invention relates to cable clips, specifically to a cable clip that ties cables together so that each cable can be easily identified, and that allows the bound cables to be easily transported and easily placed into their designated location. Additionally, the clip will also prevent cables from getting entangled, and allows specific cables to be easily removed and/or replaced while leaving all other cables in place. The cable clip is primarily designed for Thermocouple Cables (TC's), but can also be used with LAN Cables or any other type of cables.

### BACKGROUNG-DESCRIPTION OF PRIOR ART

Zip-Ties are currently used to tie TC's, together. Zip-Ties will tie the TC's together randomly and not in an organized fashion, so that Zip-Ties cannot be used to identify each Thermocouple Cable (TC).

Additionally, when using Zip-Ties, the TC's get entangled; since they are bound together so closely. Untangling TC's is very time consuming process.

And sometimes there are instance where from a set of TC's that are tied together in a Zip-Tie, only one TC needs to replaced. This requires that all TC's are untied, just to remove one TC.

Note, a TC is used to measure the temperature at certain location. TC's are cables that are placed from a SIM of a Kaye Validator to their designated locations within a Warehouse, Refrigerator, Freezer, etc. A SIM can hold 12 TC's. Zip-Ties are also used to tie LAN Cables together.

### BRIEF SUMMARY OF THE INVENTION

A cable clip that can be used to tie TC's together. Compared to Zip-Ties, the cable clip allows the TC's to be easily identified; and prevent the TC's from getting entangled, since there is a separation between them, so as to prevent them from twisting together. The cable clip also allows an individual or several individual TC's to be easily removed and/or replaced, while leaving the other TC's in-place. And compared to other organizing cable clips of the prior art, the cable clip allows the bound TC's to be easily transported and easily placed into their designated location. The cable clip can also be used with LAN Cables or any other type of cables.

Despite all of the advantages the cable clip provides, no such device currently exits on the market. If it was obvious, it would have been already implemented because the amount of work and time it will save. The unexpected results are: it allows binding TC's quickly and securely, it allows binding TC's so that they can be identified, it prevents TC's from getting entangled, it allows a specific TC to be easily replaced while leaving all other TC's in place. And it also allows bound TC's to be easily transported and placed into their designated location; so that it doesn't have any disadvantage over Zip-Tie, which the organizing cable clips of the prior art have.

### BRIEF DESCRIPTION OF THE SEVERAL VIEWS OF THE DRAWING

FIG. 1 shows a front-view of a Clip 1A.

FIG. 2 shows a top-view of a Clip 1A.

FIG. 3 shows a top-view of a Clip 1A; for which Rear Strap 1 is sufficiently separated from Front Strap 2, so as to allow cables to be inserted between them.

FIG. 4 shows a top-view of a cable clip that is identical to Clip 1A, except that flexible End Wall 3 of Clip 1A is replaced with a stiff End Wall 11 and a Hinge 12 for this cable clip.

FIG. 5 shows a front-view of a Clip 1B.

FIG. 6 shows a top-view of a Clip 1B.

FIG. 7 shows a top-view of a Clip 1C.

FIG. 8 shows a top-view of a Clip 1D.

FIG. 9 shows a front-view of a Clip 1D.

FIG. 10 shows a rear-view of a Clip 1D.

FIG. 11 shows a top-view of a Clip 1D; for which Rear Strap 16 is sufficiently separated from Cavity Block 13 so as to allow cables to be inserted between Rear Strap 16 and Cavity Block 13, and for which Front Strap 17 is sufficiently separated from Cavity Block 13 so as to allow cables to be inserted between Front Strap 17 and Cavity Block 13.

FIG. 12 shows a top-view of a cable clip that is identical to Clip 1D, except that flexible End Wall 18 of Clip 1D is replaced with a stiff End Wall 23 and a Hinges 24 for this cable clip.

FIG. 13 shows a top-view of a Clip 1E.

FIG. 14 shows a front-view of a Clip 1E.

FIG. 15 shows a rear-view of a Clip 1E.

FIG. 16 shows a top-view of a Clip 1F.

### DETAILED DESCRIPTION OF THE INVENTION

### First Embodiment—Single Row Clip

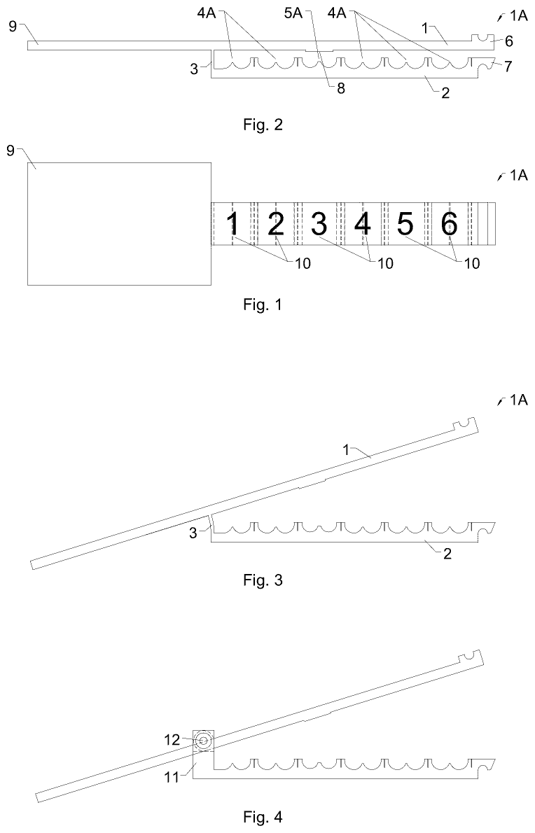

A Clip 1A is shown in FIGS. 1 to 3. Clip 1A has a Rear Strap 1 and a Front Strap 2 that are joined at one end (which is the closed-end of Clip 1A) by an End Wall 3. End Wall 3 should be flexible enough so that Rear Strap 1 can be sufficiently separated from Front Strap 2 so as to allow cables to be inserted between Rear Strap 1 and a Front Strap 2 (see FIG. 3).

Alternatively, in order to allow Rear Strap 1 to be sufficiently separated from Front Strap 2; instead of a flexible End Wall 3, a stiff End Wall 11 and a Hinge 12 can be used (see FIG. 4). Note: The term Rear Strap and Front Strap are interchangeable; meaning that the features shaped on the Rear Strap can be shaped on the Front Strap instead, and vice-versa.

Front Strap 2 has multiple Cavities 4A and only one Unique Tighter Cavity 5A, which cavity dimension is smaller/tighter than that of Cavities 4A (see FIG. 2). It is recommended that Unique Tighter Cavity 5A is the middle or near middle cable cavity of Clip 1A.

Cavities 4A and Unique Tighter Cavity 5A are used to laterally separate each cable inserted into Clip 1A. As such, Cavities 4A and Unique Tighter Cavity 5A should each be shaped so that they can each laterally contain a separate cable. Cavities 4A and Unique Tighter Cavity 5A should also keep the cables in place when Rear Strap 1 is separated from Front Strap 2.

Cavities 4A should not grip the cables tightly, this allows the cables to slide longitudinally relative to Cavities 4A.

And Unique Tighter Cavity 5A should grip its cable tightly so as to prevent its cable to slide longitudinally relative to it. Only gripping one cable tightly allows the bound cables held by Clip 1A to easily bend sideways, so that they can be easily transported and placed into their designated location.

It is recommended that Cavities 4A and Unique Tighter Cavity 5A cover slightly more than half of the circumference of the cables to be inserted into them. This will keep the cables inserted into them in place when Rear Strap 1 is opened; which allows individual cables to be removed, while leaving the other cables in place.

In order to be able to lock and unlock Rear Strap 1 relative to Front Strap 2, so as to be able to lock and unlock the cables inserted into Clip 1A to Clip 1A, a Clamping Surface 6 is shaped at the open end of Rear Strap 1 and Clamping Surface 7 is shaped at the open end of Front Strap 2. Clamping Surface 6 and Clamping Surface 7 each have an indentation for a flexible strap (such as a rubber band for example) on their outer facing surfaces. So that a flexible strap can be used to lock Clamping Surface 6 and Clamping Surface 7 together; so as to lock Rear Strap 1 to Front Strap 2, which will keep the cables within Clip 1A secure. And to unlock Rear Strap 1 from Front Strap 2, so that the cables can be removed from Clip 1A; the “flexible strap used” can simply be removed.

In order to have Rear Strap 1 only apply clamping pressure on the cable inserted into Unique Tighter Cavity 5A, a Protrusion 8 is shaped on Rear Strap 1 (see FIG. 2).

Protrusion 8 is a raised surface on “the surface of Rear Strap 1 that is facing Unique Tighter Cavity 5A”. Protrusion 8 is thick enough and its width is limited so that when Rear Strap 1 is locked to Front Strap 2; Rear Strap 1, through Protrusion 8, only applies clamping pressure on the cable inserted into Unique Tighter Cavity 5A. This will help fix Clip 1A longitudinally relative to its cables, while allowing the bound cables to be flexible so that they can be easily transported and placed into their designated location. As an illustration, having clamping pressure on the cables to the left and to the right of the cable inserted into Unique Tighter Cavity 5A will significantly reduce the sideways flexibility of the bound cables, such that it will be almost impossible to bend the bound cables sideways.

Clip 1A also has a Tag Surface 9; and Sequential Identification Numbers 10, for identifying each cable, marked on Front Strap 2 and/or Rear Strap 1.

Each Sequential Identification Number 10 is positioned on Front Strap 2 and/or Rear Strap 1 so that a cable can be identified by it; such as positioned in front of a cable for example (see FIG. 1). Sequential Identification Numbers 10 should be sequential numbers; that preferably, but not necessarily, start at 1. For example, each cavity can be numbered consecutively from 1 to the final cavity; such as 1 to 6 for example.

And Tag Surface 9 can be used to identify each cable within Clip 1A through Sequential Identification Numbers 10. For example, by making a note “Thermocouples #6 to #12” on Tag Surface 9; it can be deduced that Sequential Identification Number 10 for 1=Thermocouples #6, Sequential Identification Number 10 for 2=Thermocouples #7, etc.). Or, Tag Surface 9 can also be prelabeled, such as 1:______, 2:______, 3:______, etc.

Sequential Identification Numbers 10 can also be used without Tag Surface 9 if desired; since memory or other markers (color coding, etc.) can be used.

The main purpose of the clips of this disclosure is to hold TC's together. The main reason In-line Cable Clips are not used for TC's is because the SIM of a Kaye Validator holds 12 TC's; such that the obvious choice for the amount cable cavities is 12. Since TC's are always tied together using a zip-tie per SIM.

But placing 12 TC's in an In-line Cable Clip is not practical; because this would make it difficult to transport the bound TC's and place them into their designated location. Since the bound TC's will be very stiff, and as such very difficult to work with.

The ideal amount of total cable cavities used (including all Cavities 4A and Unique Tighter Cavity 5A, if used) for TC's is 6. TC's are often used for temperature mapping of refrigerators. And usually, 4 to 6 TC's are used per shelf; such as: one at each corner, one in the center, and one at the temperature controlling probe. Six TC's allow for the maximum amount of TC's per shelf. And allows the total TC's of a SIM to be split in 2. Twelve TC's would be too much, and splitting the TC's of a SIM to less than 6 would be cumbersome and unnecessary. A cable clip of this disclosure can used with spare cable cavities, and TC's from different SIM's can be used within a cable clip. It is not obvious to use less cable cavities than the maximum amount of TC's of a SIM; as such, using 6 instead of 12 cable cavities is unconventional. But obviously the clips of this disclosure do not have to have 6 cable cavities, they can have more or less cable cavities.

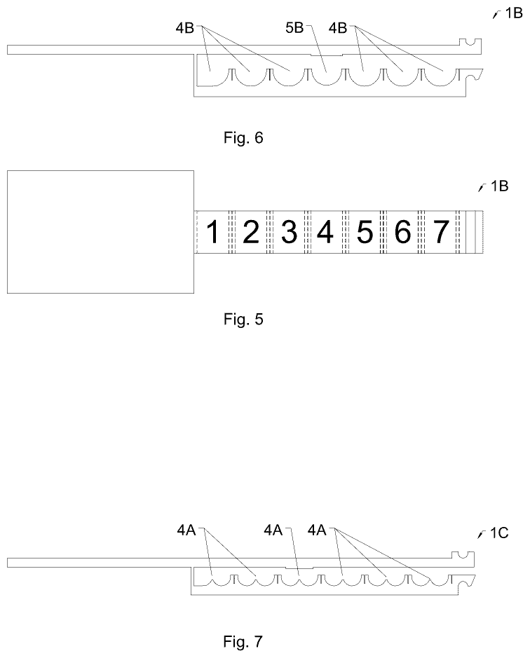

Clip 1A has multiple Cavities 4A and a Unique Tighter Cavity 5A that are for TC's. Cavities 4A and Unique Tighter Cavity 5A can be replaced with cable cavities for other type of cables; such LAN Cables, Electrical Cables, etc. FIGS. 5 and 6 show a Clip 1B, which is identical to Clip 1A; except that instead of multiple Cavities 4A and a Unique Tighter Cavity 5A that are for TC's, it has multiple Cavities 4B and a Unique Tighter Cavity 5B that are for LAN Cables.

Additionally, Clip 1B doesn't have a total amount of 6 cable cavities, since the advantage that a total amount of 6 cable cavities provide for TC's might be not applicable to other cables. A total of amount of 6 cable cavities includes all cable cavities used; including all Cavities 4A and Unique Tighter Cavity 5A, if used.

FIG. 7 shows a Clip 1C. Clip 1C is identical to Clip 1A, except that Unique Tighter Cavity 5A is replaced by another Cavity 4A, so that it only has Cavities 4A. Here Protrusion 8 simply applies clamping pressure on one Cavity 4A. The Cavity 4A on which Protrusion 8 applies clamping pressure is preferably the middle or near middle Cavity 4A.

### Second Embodiment—Double Row Clip

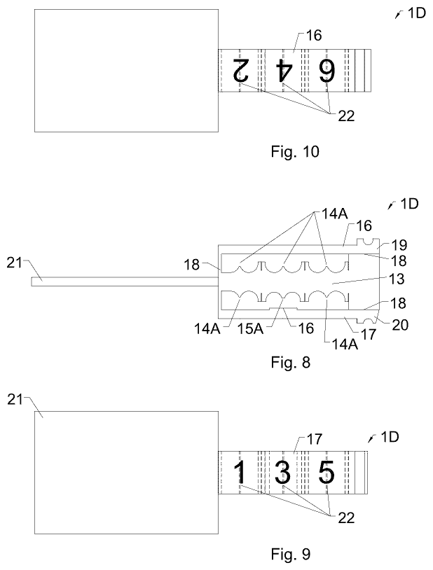

FIGS. 8 to 10 shows a Clip 1D. Clip 1D is almost identical to Clip 1A, except that it has two rows of cable cavities instead of just one. This will reduce the overall width of the clip, so that the bound cables will be easier to work with. Only “the center cavity of one row” should grip its cable tightly. This allows the cable clip to be held in place relative to its cables, while allowing the bound cables to flex and bend easily. If desired the same concept can be expanded to more than two rows.

In detail, Clip 1D has two oppositely positioned rows of cable cavities shaped on a Cavity Block 13; one row is shaped on the rear-side of Cavity Block 13, and the other row is shaped on the front-side of Cavity Block 13. Each row has preferably the same amount of cable cavities, which are each for a cable.

The row shaped on the rear-side of Cavity Block 13 has multiple Cavities 14A; while the row shaped on the front-side of Cavity Block 13 has multiple Cavities 14A and only one Unique Tighter Cavity 15A, which cavity dimension is smaller/tighter than that of Cavities 14A (see FIG. 8). Note: The term rear-side and front-side are interchangeable; meaning that the features shaped on the rear-side of Cavity Block 13 can be shaped on the front-side of Cavity Block 13 instead, and vice-versa.

It is recommended that Unique Tighter Cavity 15A is the middle or near middle cable cavity of the front-side of Cavity Block 13.

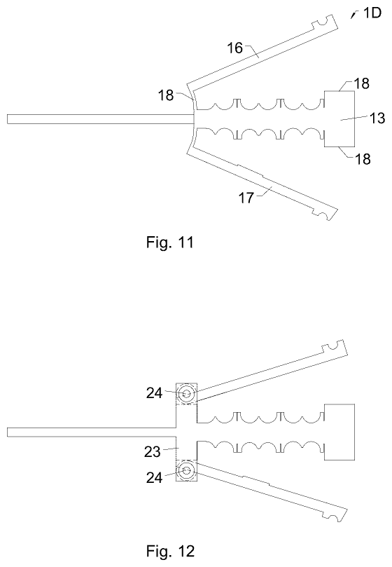

Cavities 14A and Unique Tighter Cavity 15A are used to laterally separate each cable inserted into Clip 1D. As such, Cavities 14A and Unique Tighter Cavity 15A should each be shaped so that they can each laterally contain a separate cable. Cavities 14A and Unique Tighter Cavity 15A should keep the cables in place when Rear Strap 16 and/or Front Strap 17 are opened, as shown in FIG. 11.

Cavities 14A should not grip the cables tightly, this allows the cables to slide longitudinally relative to Cavities 14A.

And Unique Tighter Cavity 15A should grip its cable tightly so as to prevent its cable to slide longitudinally relative to it. Only gripping one cable tightly allows the bound cables held by Clip 1D to bend easily, so that they can be easily transported and placed into their designated location.

Shaped to the rear of Cavity Block 13 is a Rear Strap 16, and shaped to the front of Cavity Block 13 is a Front Strap 17. Clip 1D has an open-end, through which cables can inserted, and a close-end. An End Wall 18 is used to join Rear Strap 16 and Front Strap 17 to Cavity Block 13 at one end of Clip 1D, which is the closed-end of Clip 1D.

End Wall 18 extends to the rear and to the front of Cavity Block 13 at the closed-end of Clip 1D (see FIG. 8). The extension of End Wall 18 to the rear of Cavity Block 13 is used to join Rear Strap 16 to Cavity Block 13; and the extension of End Wall 18 to the front of Cavity Block 13 is used to join Front Strap 17 to Cavity Block 13.

End Wall 18 should be flexible enough so that Rear Strap 16 can be sufficiently separated from Cavity Block 13, so as to allow cables to be inserted between Rear Strap 16 and the rear-side of Cavity Block 13. And End Wall 18 should also be flexible enough so that Front Strap 17 can be sufficiently separated from Cavity Block 13, so as to allow cables to be inserted between Front Strap 17 and the front-side Cavity Block 13 (see FIG. 11).

Alternatively, in order to allow Rear Strap 16 and Front Strap 17 to be sufficiently separated from Cavity Block 13; flexible End Wall 18 can be replaced with a stiff End Wall 23 and Hinges 24, which are each located at one end of End Wall 23 (see FIG. 12).

In order to be able to lock and unlock Rear Strap 16 relative to Front Strap 17, and such also to be able to lock and unlock Rear Strap 16 and Front Strap 17 relative to Cavity Block 13; a Clamping Surface 19 is shaped at the open end of Rear Strap 16, and Clamping Surface 20 is shaped at the open end of Front Strap 17 (see FIGS. 8 and 11).

Clamping Surface 19 and Clamping Surface 20 each have an indentation for a flexible strap, such as a rubber band for example, on their outer facing surfaces. So that a flexible strap can be used to lock Clamping Surface 19 and Clamping Surface 20 together; so as to lock Rear Strap 16 and Front Strap 17 to Cavity Block 13, which will keep the cables within Clip 1D secure. And to unlock Rear Strap 16 and Front Strap 17 from Cavity Block 13, so that the cables can be removed from Clip 1D; the “flexible strap used” can simply be removed.

Shaped on the open-end of Cavity Block 13 are two oppositely positioned Strap Stops 18 (see FIGS. 8 and 11). One Strap Stop 18 prevents Rear Strap 16 from applying any pressure on the cables that are inserted into Cavities 14A that are shaped on the rear-side of Cavity Block 13; and the other Strap Stop 18 prevents Front Strap 17 from applying any pressure on the cables that are inserted into Cavities 14A that are shaped on the front-side of Cavity Block 13.

In order to have Front Strap 17 apply clamping pressure only on the cable inserted into Unique Tighter Cavity 15A, a Protrusion 16 is shaped on Front Strap 17 (see FIG. 8).

Protrusion 16 is a raised surface on “the surface of Front Strap 17 that is facing Unique Tighter Cavity 15A”. Protrusion 16 is thick enough and its width is limited so that when Front Strap 17 is locked to Cavity Block 13; Front Strap 17, through Protrusion 16, only applies clamping pressure on the cable inserted into Unique Tighter Cavity 15A. This will help fix the clip longitudinally relative to its cables, while allowing the bound cables to be flexible so that they can be easily transported and placed into their designated location.

Clip 1D also has a Tag Surface 21; and Sequential Identification Numbers 22, for identifying each cable, marked on Rear Strap 16 and Front Strap 17.

Each Sequential Identification Number 22 is positioned on Rear Strap 16 and Front Strap 17 so that a cable can be identified by it; such as positioned in front of a cable for example (see FIGS. 9 and 10). Sequential Identification Numbers 22 should be sequential numbers; that preferably, but not necessarily, start at 1. For example, each cavity can be numbered consecutively from 1 to the final cavity; such as 1 to 6 for example.

It is preferred that Sequential Identification Numbers 22 are placed so that the sequential numbering for the Sequential Identification Numbers 22 alternate between Rear Strap 16 and Front Strap 17. Such as for example, the Sequential Identification Number for number 1 is on Front Strap 17 (see FIG. 9), the Sequential Identification Number for number 2 is on Rear Strap 16 (see FIG. 10), the Sequential Identification Number for number 3 is on Front Strap 17 (see FIG. 9), the Sequential Identification Number for number 4 is on Rear Strap 16 (see FIG. 10), the Sequential Identification Number for number 5 is on Front Strap 17 (see FIG. 9), and the Sequential Identification Number for number 6 is on Rear Strap 16 (see FIG. 10).

And Tag Surface 21 can be used to identify each cable within Clip 1D through Sequential Identification Numbers 22. For example, by making a note “Thermocouples #6 to #12” on Tag Surface 21; it can be deduced that Sequential Identification Number 10 for 1=Thermocouples #6, Sequential Identification Number 10 for 2 =Thermocouples #7, etc.). Or, Tag Surface 21 can also be prelabeled, such as 1:______, 2:______, 3:______, etc.

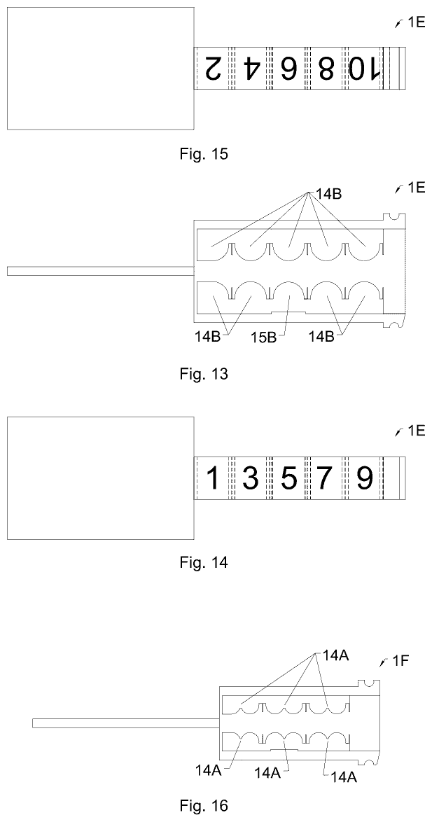

Clip 1D has multiple Cavities 14A and a Unique Tighter Cavity 15A that are for TC's. Cavities 14A and Unique Tighter Cavity 15A can be replaced with cable cavities for other type of cables; such LAN Cables, Electrical Cables, etc. FIGS. 13 to 15 show a Clip 1E, which is identical to Clip 1D; except that instead of multiple Cavities 14A and a Unique Tighter Cavity 15A that are for TC's, it has multiple Cavities 14B and a Unique Tighter Cavity 15B that are for LAN Cables.

Additionally, Clip 1E doesn't have a total amount of 6 cable cavities, since the advantage that a total amount of 6 cable cavities provide for TC's might be not applicable to other cables. A total of amount of 6 cable cavities includes all cable cavities used; including all Cavities 14A and Unique Tighter Cavity 15A, if used.

FIG. 16 shows a Clip 1F. Clip 1F is identical to Clip 1D, except that Unique Tighter Cavity 15A is replaced by another Cavity 14A, so that it only has Cavities 14A. Here Protrusion 16 simply applies clamping pressure on one Cavity 14A. The Cavity 14A on which Protrusion 16 applies clamping pressure is preferably the middle or near middle Cavity 14A of the front-side of Cavity Block 13.

### PREFERRED EMBODIMENT OF THE INVENTION (BEST MODE)

The preferred embodiment of the invention is Clip 1D.

### Conclusion, Ramifications, and Scope

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. A cable clip that ties cables together so that each cable can be easily identified, and that allows the bound cables to be easily transported and easily placed into their designated location, comprising:
a) a Front Strap, said Front Strap has multiple Cavities; and only one Unique Tighter Cavity, which cavity dimension is smaller/tighter than that of said Cavities;
b) a Rear Strap; said Rear Strap can be sufficiently separated from said Front Strap so as to allow cables to be inserted between said Rear Strap and said Front Strap;
c) an End Wall, which is used to join said Rear Strap and said Front Strap at one end, which is the closed-end of said cable clip;
d) a means for locking and unlocking said Front Strap to said Rear Strap;
e) a Protrusion that is shaped on said Rear Strap; said Protrusion is a raised surface on the surface of said Rear Strap that is facing said Unique Tighter Cavity;
said Protrusion is thick enough and its width is limited so that when said Rear Strap is locked to said Front Strap; said Rear Strap, through said Protrusion, only applies clamping pressure on the cable inserted into said Unique Tighter Cavity.

2. The cable clip of claim 1, wherein said cable clip also has Sequential Identification Numbers, for identifying each cable, marked on said Rear Strap and/or said Front Strap; said Sequential Identification Numbers are sequential numbers.

3. The cable clip of claim 2, wherein said cable clip also has a Tag Surface, said Tag Surface can be used to identify each cable within said cable clip through said Sequential Identification Numbers.

4. The cable clip of claim 3, wherein said cable clip has a total amount of 6 cable cavities, which is the ideal amount of cable cavities for Thermocouple Cables.

5. The cable clip according to any claims 1 to 4, wherein said Unique Tighter Cavity is replaced by another said Cavity, so that it only has said Cavities.

6. A cable clip that ties cables together so that each cable can be easily identified, and that allows the bound cables to be easily transported and easily placed into their designated location, comprising:
a) a Cavity Block on which two oppositely positioned rows of cable cavities are shaped;
the row shaped on the rear-side of said Cavity Block has multiple Cavities; while the row shaped on the front-side of said Cavity Block has multiple said Cavities and only one Unique Tighter Cavity, which cavity dimension is smaller/tighter than that of said Cavities;
b) a Rear Strap which is shaped to the rear of said Cavity Block; said Rear Strap can be sufficiently separated from said Cavity Block, so as to allow cables to be inserted between said Rear Strap and the rear-side of said Cavity Block;
c) a Front Strap which is shaped to the front of said Cavity Block; said Front Strap can be sufficiently separated from said Cavity Block, so as to allow cables to be inserted between said Front Strap and the front-side of said Cavity Block;
d) an End Wall, which is used to join said Rear Strap and said Front Strap to said Cavity Block at one end, which is the closed-end of said cable clip;
e) a means for locking and unlocking said Rear Strap and said Front Strap to said Cavity Block;
f) two oppositely positioned Strap Stops shaped on the open-end of said Cavity Block;
one said Strap Stop prevents said Rear Strap from applying any pressure on the cables that are inserted into said Cavities that are shaped on the rear-side of said Cavity Block; and the other said Strap Stop prevents said Front Strap from applying any pressure on the cables that are inserted into said Cavities that are shaped on the front-side of said Cavity Block;
g) a Protrusion that is shaped on said Front Strap; said Protrusion is a raised surface on the surface of said Front Strap that is facing said Unique Tighter Cavity;
said Protrusion is thick enough and its width is limited so that when said Front Strap is locked to said Cavity Block; said Front Strap, through said Protrusion, only applies clamping pressure on the cable inserted into said Unique Tighter Cavity.

7. The cable clip of claim 6, wherein said cable clip also has Sequential Identification Numbers, for identifying each cable, marked on said Rear Strap and said Front Strap; said Sequential Identification Numbers are sequential numbers.

8. The cable clip of claim 7, wherein said cable clip also has a Tag Surface, said Tag Surface can be used to identify each cable within said cable clip through said Sequential Identification Numbers.

9. The cable clip of claim 8, wherein said cable clip has a total amount of 6 cable cavities, which is the ideal amount of cable cavities for Thermocouple Cables.

10. The cable clip according to any claims 6 to 9, wherein said Unique Tighter Cavity is replaced by another said Cavity, so that it only has said Cavities.
